(19) United States
(12) Patent Application Publication
(10) Pub. No.: US 2006/0040022 A1
(43) Pub. Date: Feb. 23, 2006

(54) Chilled food composition

(75) Inventor: Moez Mohamed Bouraoui, Clifton, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America, Division of Conopco, Inc.

(21) Appl. No.: 10/923,400

(22) Filed: Aug. 20, 2004

(51) Int. Cl. A23L 3/3463

(52) U.S. Cl. 426/335

(57) ABSTRACT

Chilled food compositions having a pH of under 4.5 are described. The chilled food compositions are emulsion-based and contain fresh vegetables. The chilled food compositions are free of discoloration and microbiologically stable when kept refrigerated.

### FIELD OF THE INVENTION

The present invention is directed to chilled food compositions. More particularly, the present invention is directed to chilled food compositions that are unexpectedly free of synersis, free of discoloration and microbiologically stable for at least about 40.0 days when kept refrigerated. The chilled food compositions of the present invention preferably have a pH of less than about 4.50, are not sour and do not impair the textures of vegetables present within the same.

### BACKGROUND OF THE INVENTION

Ready-to-eat meals are more popular than ever in view of the hectic work schedules of many consumers. Ready-to-eat salads, like coleslaw, chicken and turkey salad, tuna salad, ham salad and egg salad are extremely popular because they are not considered to be high carbohydrate comprising foods, and therefore, desired options for low carbohydrate diets. Salads, like ready-to-eat potato salad and macaroni salad, still remain favorites of consumers since not all consumers are on low carbohydrate fad diets and reduced carbohydrate versions of characteristically high carbohydrate foods exist.

Notwithstanding the popularity of many ready-to-eat salads, such salads, if not consumed almost immediately after manufacturing and packaging, turn brown, display synersis and become microbiologically unstable, typically within four (4) weeks of manufacturing. Moreover, such salads, even prior to becoming unedible, have very soft vegetables deplete of their characteristic crunchy texture. Thus, retailers and consumers are typically afforded little to no opportunity to keep such salads for an extended period of time.

It is of increasing interest to develop ready-to-eat salads that look and taste fresh, are microbiologically stable and display good vegetable textures for at least about 40.0 days when kept refrigerated. This invention, therefore, is directed to chilled food compositions that are surprisingly free of synersis, free of discoloration and microbiologically stable for at least about 40.0 days when kept refrigerated. The chilled food compositions of this invention preferably comprise fresh vegetables, and the vegetables do not lose their characteristic crunchy textures when mixed within the chilled food compositions.

### ADDITIONAL INFORMATION

Efforts have been disclosed for making food compositions. In UK Patent Specification 904,881, food additives and food compositions which can be stored without appreciable loss of flavor and without fear of creating a health hazard are described.

Other efforts have been disclosed for making food compositions. In U.S. Pat. No. 3,038,810, food salads which can be stored for periods of time are described.

Still other efforts have been made for making food compositions. In European Patent No. EP 0 293 547, food systems are protected from gram-positive bacterial spoilage by the incorporation of bacteriocin.

None of the additional information above describes a chilled food composition having a pH of preferably less than about 4.5 wherein the chilled food composition is not discolored and sour, free of synersis, and microbiologically stable for at least about 40.0 days when kept refrigerated.

### SUMMARY OF THE INVENTION

In a first aspect, the present invention is directed to a chilled food composition comprising:

(a) an emulsion; and

(b) vegetable, fruit, a cereal-based source, meat, fish or a mixture thereof wherein the chilled food composition has a pH of less than about 4.5.

In a second aspect, the present invention is directed to a method for making the chilled salad of the first aspect of the invention.

Chilled salad, as used herein, means a salad made with an oil-in-water emulsion whereby the salad is refrigerated when stored. Refrigerated, as used herein, means stored in a refrigerator and kept at a temperature from about 1.5° C. to about 5.5° C. Free of synersis and free of discoloration means substantially no visual water separation and substantially no visual color change for at least about 40.0 days (preferably at least about 50.0 days) when kept refrigerated and when compared to freshly made chilled compositions. Microbiologically stable, as used herein, means no outgrowth of bacteria, yeast and/or mold for at least about 40.0 days when kept refrigerated. Cereal-based, as used herein, means comprising grain.

### DETAILED DESCRIPTION OF THE PREFERRED EMBODIMENTS

There is no limitation with respect to the type of emulsion that may be used in the chilled food composition of this invention other than that the emulsion is one which is suitable for human consumption. Preferably, however, the emulsion used in the chilled food composition of the present invention is an oil-in-water emulsion.

Illustrative examples of the types of oil which may be used to make the emulsion employed in this invention include, without limitation, those which are liquid at ambient temperature like avocado, mustard, coconut, cottonseed, fish, flaxseed, grape, olive, palm, peanut, rapeseed, safflower, sesame, soybean, sunflower, mixtures thereof or the like.

Other types of oils which may be used in this invention are solid at ambient temperature. Illustrative examples of the oils which are solid at room temperature and suitable for use in this invention include, without limitation, butter fat, chocolate fat, chicken fat, mixtures thereof or the like.

In a preferred embodiment, the oil used in this invention is a liquid at ambient temperature. In a most preferred embodiment, the oil used in this invention is soybean, sunflower, rapeseed oil or a mixture thereof.

The amount of oil used in the emulsion of this invention is typically more than about 7.5% by weight and less than about 85.0% by weight, based on total weight of the emulsion. Preferably, the amount of oil employed in the emulsion is from about 15.0% to about 80.0%, and most preferably, from about 50.0% to about 77.0% by weight, based on total weight of the emulsion and including all ranges subsumed therein.

The water used in this invention can be, for example, any potable surface or underground water including pure water, tap water, bottled water, deionized water, spring water, or a mixture thereof. Thus, the water used in this invention may be an aqueous solution comprising salts or minerals or both. Typically, water makes up the balance of the emulsion and the chilled food composition made with the same.

The emulsifier suitable for use in the emulsion of this invention often has an HLB of greater than about 8.0, and preferably, greater than about 11.0, and most preferably, from about 12.0 to about 18.0, including all ranges subsumed therein. Illustrative examples of the emulsifier suitable for use in this invention include, without limitation, PEG 20 tristearate, PEG 20 trioleate, PEG 20 monostearate, PEG 20 monooleate, PEG 20 monopalmitate and PEG 20 monolaurate sorbitan, derivatives thereof, mixtures thereof or the like, made available by ICI Surfactants under the names Tween or Span. The preferred emulsifier employable in this invention is, however, a protein, like vegetable, milk (e.g., whey) or soy protein, or mixtures thereof. Another preferred protein suitable for use in this invention is phospholipoprotein, and especially, egg yolk derived phospholipoprotein modified with phospholipase A as disclosed in U.S. Pat. No. 5,028,447, the disclosure of which is incorporated herein by reference.

In a preferred embodiment, the emulsion used to make the chilled food composition of this invention is real mayonnaise, light mayonnaise, or reduced fat mayonnaise. In an especially preferred embodiment, the edible emulsion used to make the chilled food composition of this invention is real mayonnaise made available by Unilever Bestfoods under the Hellmann's brand name.

There is no limitation with respect to how the cereal-based source, meat or fish (i.e., components) are prepared prior to being used to make the chilled food composition of the present invention. Such components can, therefore, be frozen, individually quick frozen, dehydrated, rehydrated, cooked, blanched, fresh, or a combination thereof. The vegetables and any fruits (when components) employed in this invention are most preferably fresh.

There is no limitation with respect to the type of vegetables used in the chilled food composition of this invention other than that the vegetables are enjoyable chilled and mixed within an emulsion. Illustrative examples of the types of vegetables suitable for use in this invention, include, without limitation, blackbeans, black-eyed peas, chickpeas, kidney beans, lentils, lima beans, mung beans, navy beans, pinto beans, split peas, corn, green peas, potatoes, asparagus, beets, brussel sprouts, cabbage, cucumbers, eggplant, peppers, lettuce, mushrooms, okra, onions, mushrooms, radishes, squash, turnips, zucchini, pumpkin, carrots, broccoli, cauliflower, garlic, mixtures thereof or the like. Fruits suitable for use in this invention include, without limitation, tomato, pears, apples, cantaloupe, mixtures thereof, or the like. The cereal-based source preferred for use in this invention can be, for example, bread, pasta, barley, rice, dumplings, combinations thereof or the like.

As to the meat suitable for use in this invention, such meat can be, for example, beef, poultry, pork, lamb, shrimp, clam, oyster, lobster, crab or a mixture thereof. The fish suitable for use in this invention is not limited and is often cod fish, flounder, fluke, salmon, tuna or a mixture thereof.

In an especially preferred embodiment, the preferred vegetables are cabbage and carrots. In yet another especially preferred embodiment, the amount of components employed in the chilled food composition of this invention is from about 5.0 to about 85.0%, and preferably from about 65.0 to about 85.0% by weight, based on total weight of the chilled food composition. Thus, emulsion typically makes up from about 5.0 to less than about 95.0%, and preferably, from about 15.0 to less than about 35.0% by weight of the chilled food composition.

While it is preferred that the emulsion used to make the chilled food composition of this invention is an oil-in-water emulsion, it is within the scope of this invention for the emulsion to be a single phase emulsion or a multiple phase emulsion, like a water-in-oil-in-water emulsion.

It is particularly noted herein that if heat treatment, like pasteurization, is not desired, the chilled food composition described herein may be acidified in order to inhibit microbiological growth. When acidified, the chilled food composition typically has enough acidulant added so that the pH of the same is from about 2.75 to less than 4.5, and preferably, from about 3.25 to about 3.80, including all ranges subsumed therein.

In an especially preferred embodiment, the pH of the chilled composition is from about 3.00 to about 3.75 when the chilled food composition is coleslaw.

There is no limitation with respect to the type of acidulant employed in this invention other than that the acidulant is one which may be used in formulations suitable for human consumption. Illustrative examples of the types of acidulants which may be used in this invention include, without limitation, acetic acid, citric acid, hydrochloric acid, lactic acid, malic acid, phosphoric acid, glucono-delta-lactone, mixtures thereof and the like. In a preferred embodiment, however, the acidulant employed in this invention is phosphoric acid. In yet another preferred embodiment, the amount of acid employed in the chilled food composition of this invention is from about 0.25 to about 1.00%, and preferably, from about 0.35 to about 0.65% by weight based on total weight of the chilled food composition, including all ranges subsumed therein.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30.0%, and most preferably, at least about 75.0% of the total weight of the oil in the emulsion.

The chilled food compositions of this invention may comprise optional additives like, for example, chocolate, nut paste, salt, onion powder, garlic powder, pepper (and other spices and seasonings), vitamins, artificial and/or natural flavors and colors, fruit puree, preservatives, antimicrobial agents, antioxidants, chelators, buffering agents, cheese, mixtures thereof and the like. Such optional additives, when used, collectively, do not make up more than about 40.0% by weight of the total weight of the chilled food composition.

The preferred preservatives suitable for use in this invention include sodium benzoate, potassium benzoate, potassium sorbate, sorbic acid, benzoic acid, mixtures thereof or the like. Antimicrobial agents suitable for use in this include those comprising nisin or the like. Anti-oxidants suitable for use in this invention include a tocopherol, ascorbic acid, ascorbyl palmitate, tertiary-butyl hydroquinone, mixtures thereof or the like. Chelators suitable for use in this invention include EDTA and its salts, citric acid, sodium tripolyphosphate, sodium carbonate, potassium carbonate, mixtures thereof or the like.

The cheese suitable for use in this invention can be skim, part skim or full fat cheese. Typical non-limiting examples of the types of cheese (including processed cheese) suitable for use in this invention include gouda, edam, leyden, cheddar, goat, cheshire, stilton, mozzarella, cream cheese, brie, feta, tilsit, mixtures thereof or the like.

Still other additives which may be optionally added to the chilled food compositions of this invention include protein sources and sweeteners. The former include caseinate and skimmed milk powder and the latter include syrups, sucrose, glucose, saccharin, aspartame, dextrose, lactose, levelose, maltose, fructose, mixtures thereof or the like.

Even other additives for use in this invention are thickening agents like starches and/or gums. Illustrative starches suitable for use in this invention include cornstarch, waxy maize, potato, rice, tapioca, wheat starch, or a mixture thereof. Illustrative gums suitable for use in this invention include guar, xanthan, agar, carrageenan and carboxymethyl cellulose or a mixture thereof. Typically, the total amount of gum and starch employed does not exceed about 0.75% based on total weight of the chilled food composition.

When making the chilled food composition of this invention, typically water and any hydrophilic components, like vegetables, are mixed together, to make a hydrophilic mixture. A pre-blend of dry ingredients (e.g., gum, starch, spices, preservatives and antimicrobial agents) is also made, producing a dry mix. The hydrophilic mixture and dry mix are then combined and mixed to produce a homogeneous dispersion or mixture to which emulsion is added (resulting in a homogeneous composition comprising emulsion). Preferably, the acidulant is then added to the resulting homogeneous composition comprising emulsion, producing the chilled food composition of this invention (after refrigeration). It should be noted that if fragile components like, fruit, meat, fish, a cereal-based source and/or potato are desired for use in the chilled food composition of this invention, such fragile components are preferably added after acidulant, and mixed within the food composition by applying gentle shear and/or folding the same into the desired composition.

The chilled food composition of this invention may be pourable, but preferably, is eaten with a fork or spoon. Moreover, the chilled food composition of this invention is preferably coleslaw, potato salad or macaroni salad. Most preferably, the chilled food composition of this invention is coleslaw.

In a preferred embodiment, less than about 3.5 units/mg of polyphenol oxidase and less than about 0.5 units/mg of peroxidase are found in the chilled food composition of this invention.

The packaging for the chilled food composition of this invention is often a glass jar, plastic tub or plastic bottle. Bottles and jars are preferred for food service applications, and plastic tubs are preferred for domestic use.

The examples which follow are provided to facilitate an understanding of the present invention. The examples are not intended to limit the scope of the claims.

### EXAMPLE 1

Chilled food compositions having the following ingredients were made:

| Ingredient | Percent by Weight |
|---|---|
| Shredded cabbage | 66.0-70.0 |
| Hellmann's Real Mayonnaise | 13.0-16.0 |
| Sugar | 5.0-7.0 |
| Shredded carrot | 7.0-8.0 |
| Phosphoric acid (85.0%) | 0.35-0.60 |
| Ultrasperse M starch* | 0.25-0.35 |
| Potassium sorbate | 0.04-0.055 |
| Sodium benzoate | 0.04-0.055 |
| Viscomix gum** | 0.08-0.12 |
| Ground pepper | 0.06-0.07 |
| Onion powder | 0.15-0.25 |

*Instant Starch - National Starch and Chemical
**Hydrocolloid Mix - Tic Gums, Inc.

The cabbage and carrots were added to a mixer (e.g., a conventional ribbon mixer) to produce homogeneous vegetable mixes. The dry ingredients were combined to make dry mixes. The vegetable mixes and dry mixes were combined, thoroughly mixed to produce a homogeneous dispersion or mixture and combined with mayonnaise to produce a homogeneous composition comprising emulsion. Phosphoric acid was added to the same to produce acidified food compositions having a pH of about 3.5. The acidified food compositions were chilled to about 5.0° C., resulting in superior coleslaw compositions in accordance with this invention.

### EXAMPLE 2

The chilled coleslaw compositions of Example 1 were compared to conventional and chilled coleslaw compositions like those purchased in a supermarket. The chilled coleslaw compositions of this invention and the conventional chilled coleslaw compositions like those purchased in the supermarket were aged to about two (2) months. Panelists were asked to assess the compositions for appearance, smell, taste and texture. Unanimously, all panelists concluded that the conventional coleslaw compositions had a foul smell, were tan, soggy, and awful tasting. About 80% of the panelists concluded that the chilled coleslaw compositions of Example 1 were crispy, good tasting, free of syneresis and of good color and aroma. The panelists also concluded that the two (2) month old chilled coleslaw compositions of Example 1 looked and tasted substantially the same as identical chilled coleslaw compositions that were only about twenty (20) days old.

The results of the example confirm that the chilled food compositions of this invention have an extended shelf-life when compared to conventional chilled food compositions.

### EXAMPLE 3

Aged coleslaw compositions made via the manner described in Example 1 were compared by panelists. The first group of coleslaw compositions was forty seven (47) days old and the second group was ten (10) days old. The panelists concluded that both groups of coleslaw had good aroma and texture, and looked and tasted substantially the same.

The results of this example confirm that the chilled food compositions of this invention retain their characteristics for at least about 40.0 days.

What is claimed is:

1. A chilled food composition comprising:
(a) an emulsion; and
(b) vegetable, fruit, a cereal-based source, meat, fish or a mixture thereof
wherein the chilled food composition has a pH of less than about 4.5.

2. The chilled food composition according to claim 1 wherein the chilled food composition has a pH from about 3.00 to about 4.25.

3. The chilled food composition according to claim 1 wherein the chilled food composition has a pH from about 3.25 to about 3.80.

4. The chilled food composition according to claim 1 wherein the chilled food composition further comprises acidulant.

5. The chilled food composition according to claim 4 wherein the acidulant is phosphoric acid.

6. The chilled food composition according to claim 4 wherein emulsion is combined with vegetable, fruit, a cereal-based source, meat, fish or a mixture thereof before the acidulant is added.

7. The chilled food composition according to claim 1 wherein the chilled food composition is coleslaw, macaroni salad or potato salad.

8. The chilled food composition according to claim 1 wherein the chilled food composition is free of syneresis, discoloration and microbiologically stable for at least about 40.0 days when kept refrigerated.

9. A method for making a chilled food composition comprising, in no particular order, the steps of:
(a) making a mixture of hydrophilic components and a mixture of dry ingredients;
(b) combining the mixture of hydrophilic components and the mixture of dry ingredients to produce a homogeneous mixture or dispersion;
(c) adding emulsion to the homogeneous composition or dispersion to produce a homogeneous mixture comprising emulsion;
(d) adding acidulant to the homogeneous mixture comprising emulsion to produce a food composition; and
(e) chilling the food composition to produce the chilled food composition.

10. The method according to claim 9 wherein the emulsion is mayonnaise.

11. The method according to claim 9 wherein the acidulant is phosphoric acid.

12. The method according to claim 9 wherein the chilled food composition has a pH of less than about 4.5.

13. The method according to claim 9 wherein the hydrophilic components comprise fresh vegetables.

14. The method according to claim 9 wherein the chilled food composition is coleslaw, macaroni salad or potato salad.

15. The method according to claim 9 wherein the chilled food composition is free of syneresis, discoloration and microbiologically stable for at least about 40.0 days when kept refrigerated.

16. The method according to claim 9 wherein the chilled food composition has a pH from about 3.25 to about 3.80.

17. The method according to claim 9 wherein the chilled food composition has less than about 3.5 units/mg of polyphenol oxidase.

18. The method according to claim 9 wherein the chilled food composition has less than about 0.25 units/mg of peroxidase.

19. A method for making a chilled food composition comprising the steps of:
(a) making a mixture of hydrophilic components and a mixture of dry ingredients;
(b) combining the mixture of hydrophilic components and the mixture of dry ingredients to produce a homogeneous mixture or dispersion;
(c) adding emulsion to the homogeneous composition or dispersion to produce a homogeneous mixture comprising emulsion;
(d) adding acidulant to the homogeneous mixture comprising emulsion to produce a food composition; and
(e) chilling the food composition to produce the chilled food composition.
